(19) United States
(12) Patent Application Publication
(10) Pub. No.: US 2019/0378652 A1
(43) Pub. Date: Dec. 12, 2019

(54) MAGNETIC INDUCTOR COIL PRINTING METHOD

(71) Applicant: AJOHO ENTERPRISE CO., LTD., Taipei (TW)

(72) Inventors: Chia-Ping MO, Taipei (TW); You-Chi LIU, Taipei (TW)

(21) Appl. No.: 16/006,298

(22) Filed: Jun. 12, 2018

(51) Int. Cl. H01F 41/04; H01F 27/28; H01F 27/24; H01F 41/12; H01F 27/32; B41M 3/00

(52) U.S. Cl. CPC H01F 41/043; H01F 27/2804; B41M 3/006; H01F 41/12; H01F 27/32; H01F 27/24

(57) ABSTRACT

A magnetic inductor coil printing method includes the step of printing at least one first coil winding on a core base, the step of printing a first insulating layer on the core base over the first coil winding, the step of printing at least one second coil winding on the core base over the first insulating layer, and the step of printing a second insulating layer on the core base over the second coil winding.

### BACKGROUND OF THE INVENTION

### 1. Field of the Invention

The present invention relates to magnetic technologies and more particularly, to a magnetic inductor coil printing method for creating an inductor by: printing one or a number of coil windings on a core base and then printing an insulating layer on the core base over the coil windings.

### 2. Description of the Related Art

As technology advances, many electronic products are designed to be light, thin, short and small. A regular transformer generally comprises a magnetic core, two enameled wires wound round the magnetic core with four lead ends thereof respectively extended to two opposite flanges of the magnetic core for the connection of a circuit of an external electronic device for conversion of voltage and current. The transformer can also be used in the circuit to filter out electromagnetic waves and other unnecessary noise signals for grounding. However, conventional transformers are too large to be used in lightweight electronic devices. Therefore, it is necessary for those who are engaged in this industry to improve.

### SUMMARY OF THE INVENTION

The present invention has been accomplished under the circumstances in view. It is therefore the main object of the present invention to provide a magnetic inductor coil printing method, which is to print at least one first coil winding on a core base, and then to print a first insulating layer on the core base over the first coil winding, and then to print at least one second coil winding on the core base over the first insulating layer, and then to print a second insulating layer on the core base over the second coil winding. With the above structure, a small transformer is created, having the advantages of small size and space saving.

It is another object of the present invention to provide a magnetic inductor coil printing method, which is to print at least one first coil winding on a core base and then to print a first insulating layer on the core base over the first coil winding, thereby creating a small inductor that has the advantages of small size and space saving.

It is still another object of the present invention to provide a magnetic inductor coil printing method, which is to print a third insulating layer on a core base, and then to print at least one third coil winding on the core base over the third insulating layer, and then to print a fourth insulating layer on the core base over the third coil winding, and then to print at least one fourth coil winding on the core base over the fourth insulating layer and then to print a fifth insulating layer on the cover base over the fourth coil winding. With the above structure, a small transformer is created, having the advantages of small size and space saving.

It is still another object of the present invention to provide a magnetic inductor coil printing method, which is to print a third insulating layer on a core base and then to print at least one third coil winding on the core base over the third insulating layer, and then to print a fourth insulating layer on the core base over the third coil winding. With the above structure, a small inductor is created, having the advantages of small size and space saving.

Other advantages and features of the present invention will be fully Understood by reference to the following specification in conjunction with the accompanying drawings, in which like reference signs denote like components of structure.

### BRIEF DESCRIPTION OF THE DRAWINGS

FIGS. 1A-1E illustrate the implementation of a magnetic inductor coil printing method to crease a magnetic inductor in accordance with a first embodiment of the present invention.

FIG. 2 is a flow chart of the magnetic inductor coil printing method in accordance with the first embodiment of the present invention.

FIGS. 3A-3F illustrate the implementation of a magnetic inductor coil printing method to crease a magnetic inductor in accordance with a second embodiment of the present invention.

FIG. 4 is a flow chart of the magnetic inductor coil printing method in accordance with the second embodiment of the present invention.

FIG. 5 is an oblique top elevation of a transformer made according to the present invention.

FIG. 6 is an oblique top elevation of another transformer made according to the present invention.

### DETAILED DESCRIPTION OF THE PREFERRED EMBODIMENT

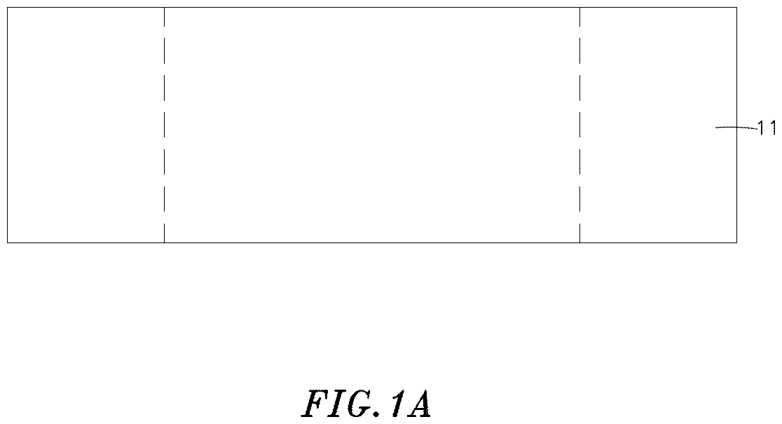

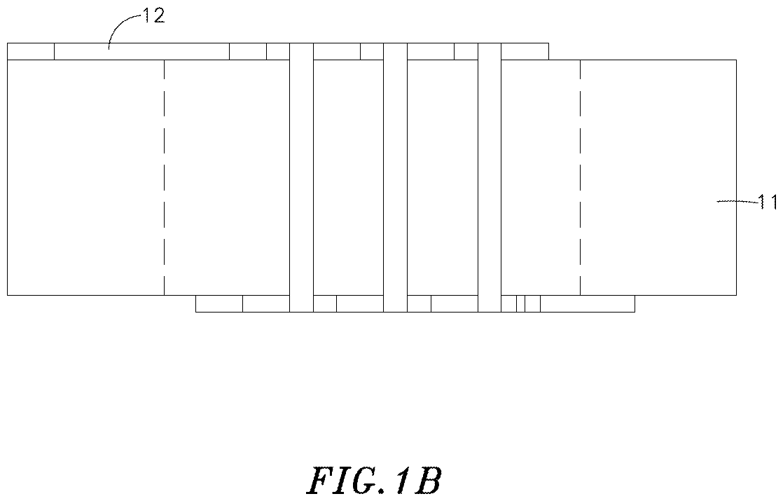

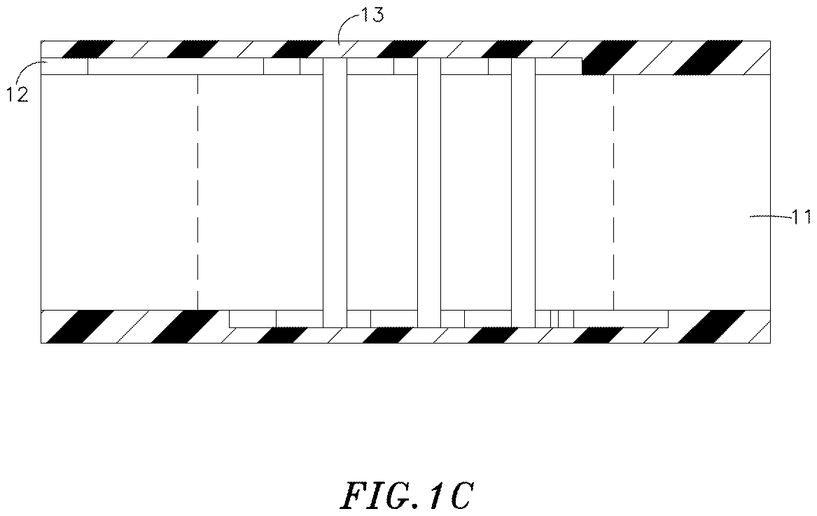

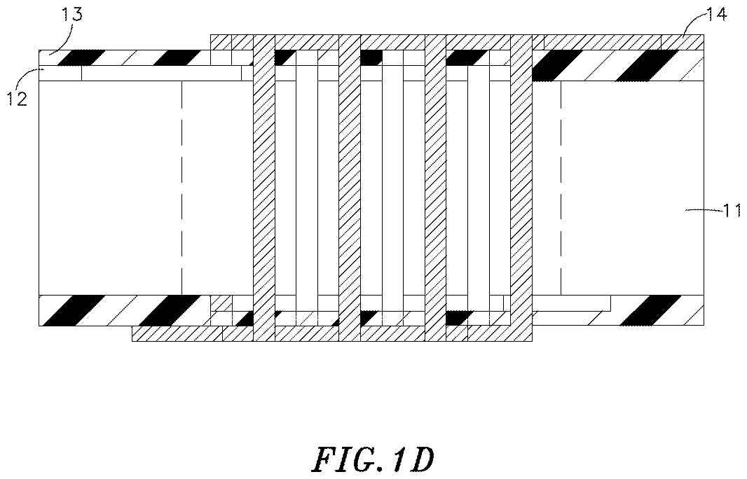

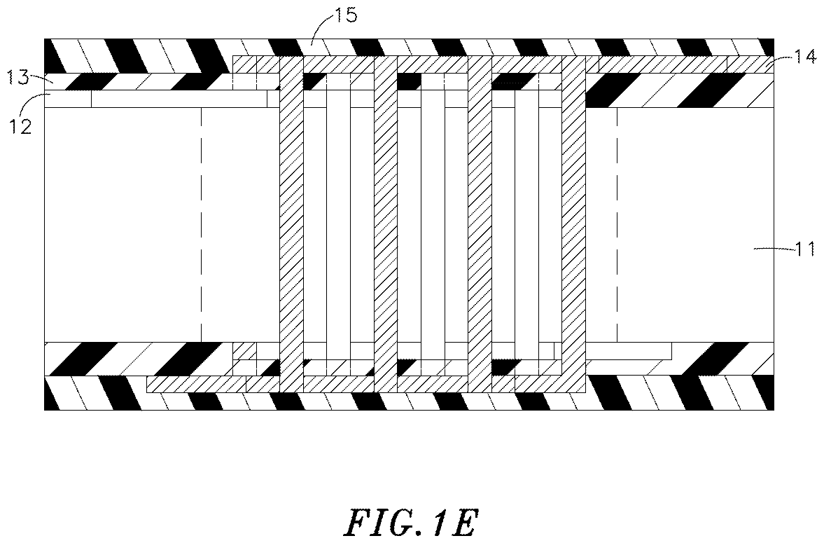

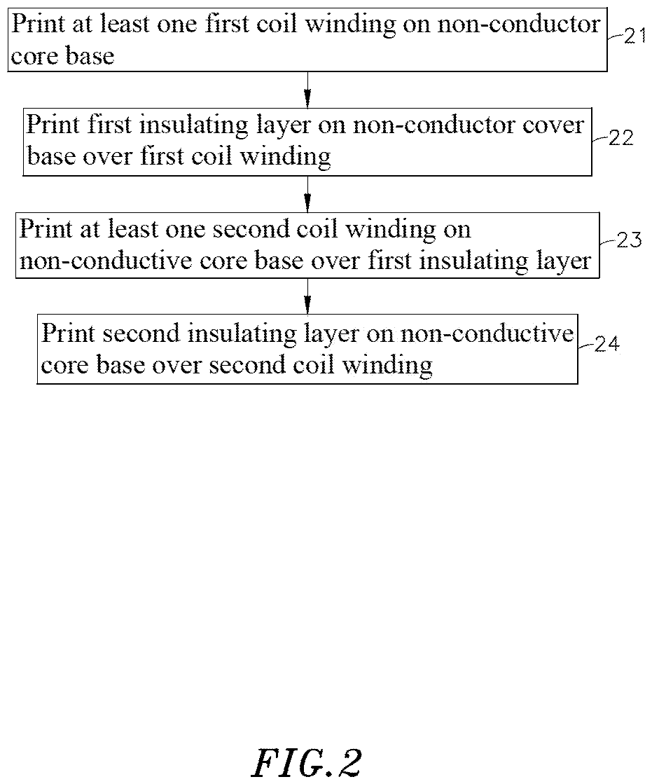

Referring to FIGS. 1A-1E and 2, a magnetic inductor coil printing method in accordance with a first embodiment of the present invention comprises the steps of:

Step 21: Print at least one first coil winding 12 on a non-conductor core base 11. The material of the non-conductor core base 11 is not electrically conductive.

Step 22: Print a first insulating layer 13 on the core base 11 over the first coil winding 12. Because there is only one first coiling winding 12 arranged around the core base 11, no mutual inductance occurs after Steps 21 and 22 are completed, so a small inductor can be formed.

Step 23: Print at least one second coil winding 14 on the core base 11 over the first insulating layer 13.

Step 24: Print a second insulating layer 15 on the core base 11 over the second coil winding 14. Because there are first and second coiling windings 12,14 arranged around the core base 11, mutual inductance occurs between the first coiling windings 12 and the second coiling windings 14 to create primary and secondary coil windings after Steps 21, 22, 23 and 24 are completed, so a small transformer can be formed.

The electrically non-conductive core base 11 is made of nickel-zinc alloy or nickel-zinc composite metal.

The first coil winding 12 and the second coil winding 14 are made of a conductive liquid. The conductive liquid is composed of conductive silver paste or other conductive liquid such as graphite paste.

The first insulating layer 13 and the second insulating layer 15 are made of an insulating liquid. The insulating liquid refers to an insulating paint or any other insulating liquid.

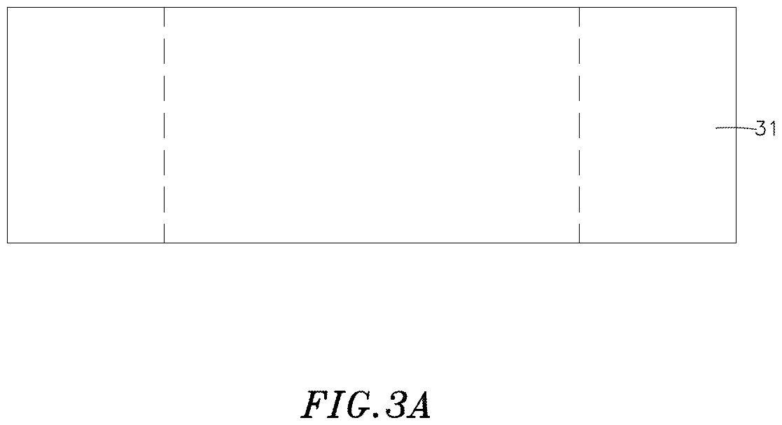

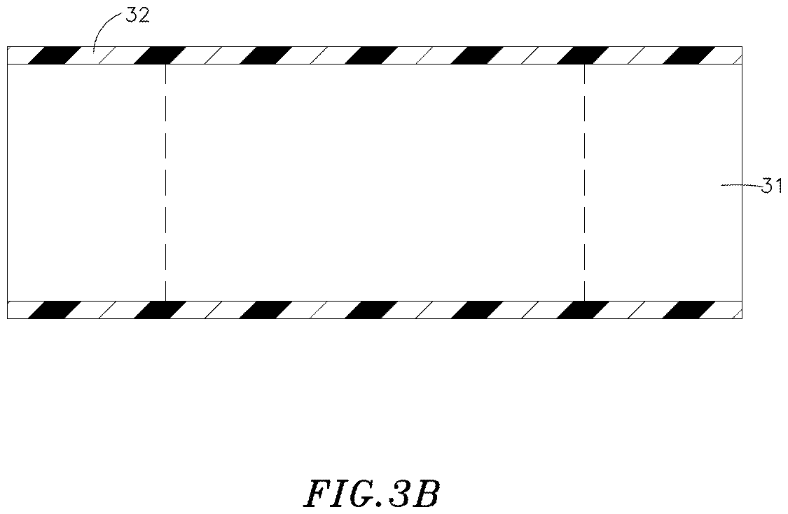

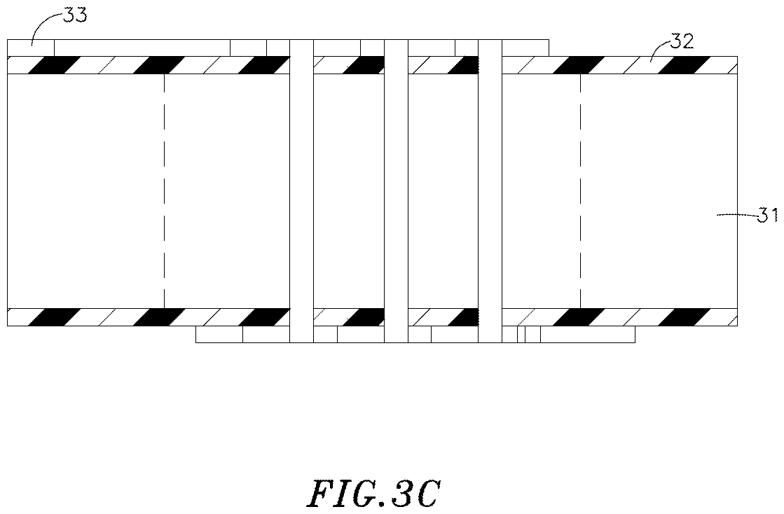

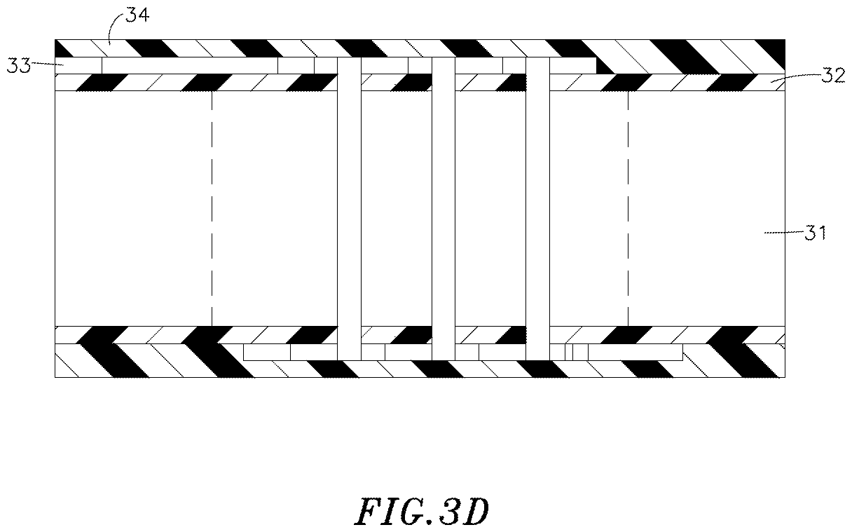

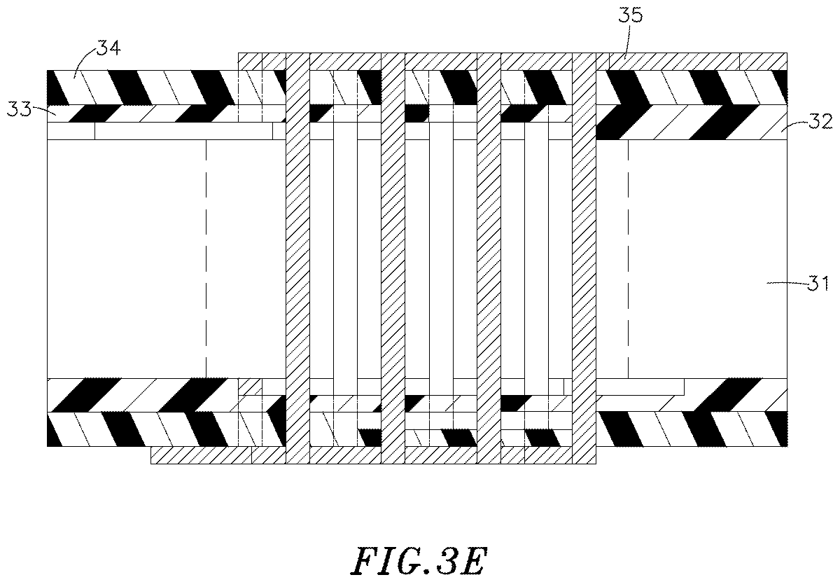

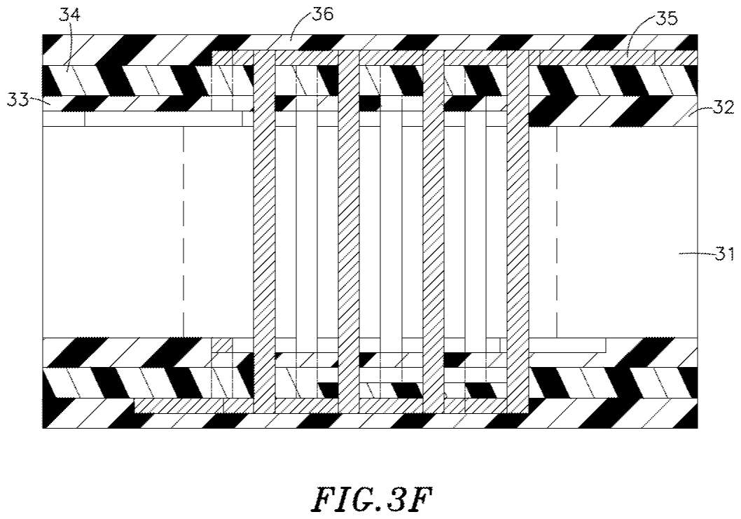

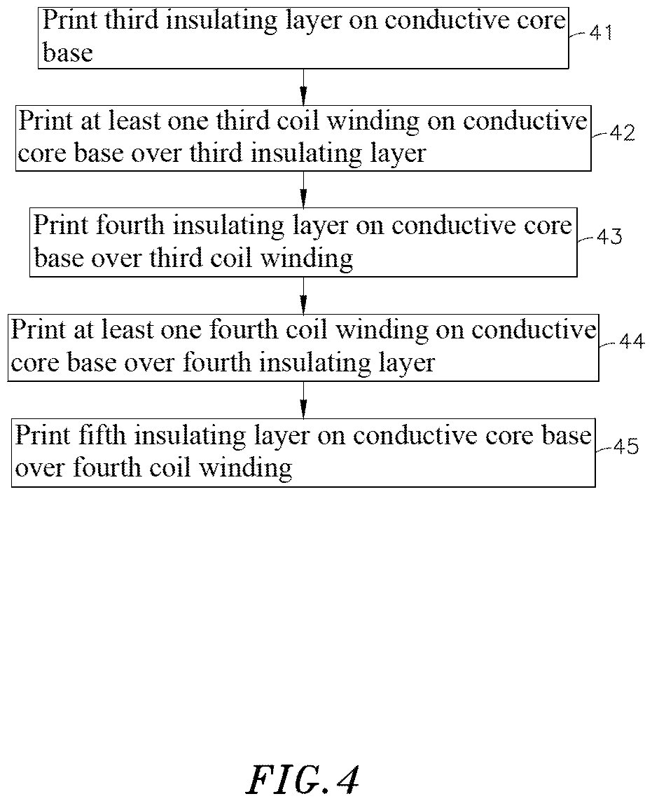

Referring to FIGS. 3A-3F and 4, a magnetic inductor coil printing method in accordance with a second embodiment of the present invention comprises the steps of:

Step 41: Print a third insulating layer 32 on a core base 31. The material of the core base 31 is electrically conductive. The third insulating layer 32 is set to prevent a short circuit between a plurality of coil windings arranged in one same layer.

Step 42: Print at least one third coil winding 33 on the core base 31 over the third insulating layer 32.

Step 43: Print a fourth insulating layer 34 on the core base 31 over the third coil winding 33. Because there is only one coiling winding arranged around the core base 31, no mutual inductance occurs after Steps 41 and 42 are completed, so a small inductor can be formed.

Step 44: Print at least one fourth coil winding 35 on the core base 31 over the fourth insulating layer 34.

Step 45: Print a fifth insulating layer 36 on the core base 31 over the fourth coil winding 35. Because there are third and fourth coiling windings 33,35 arranged around the core base 31, mutual inductance occurs between third coiling winding 33 and the fourth coiling winding 35 to create primary and secondary coil windings after Steps 41, 42, 43, 44 and 45 are completed, so a small transformer can be formed.

The electrically conductive core base 31 is made of a manganese-zinc alloy, a manganese-zinc composite metal, a silicon steel sheet, or an amorphous material.

The third coil winding 33 and the fourth coil winding 35 made of a conductive liquid. The conductive liquid is composed of conductive silver paste or other conductive liquid such as graphite paste.

The third insulating layer 32, the fourth insulating layer 34 and the fifth insulating layer 36 are made of an insulating liquid. The insulating liquid refers to an insulating paint or other insulating liquids.

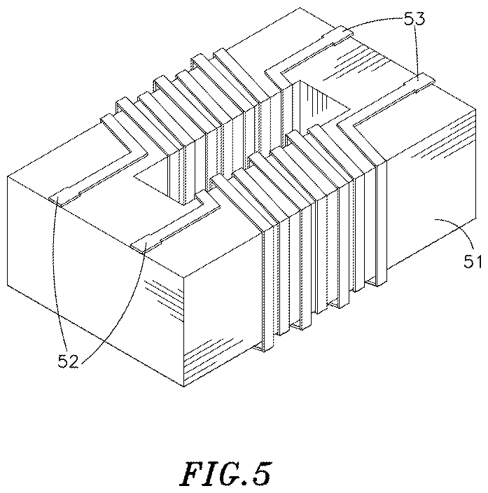

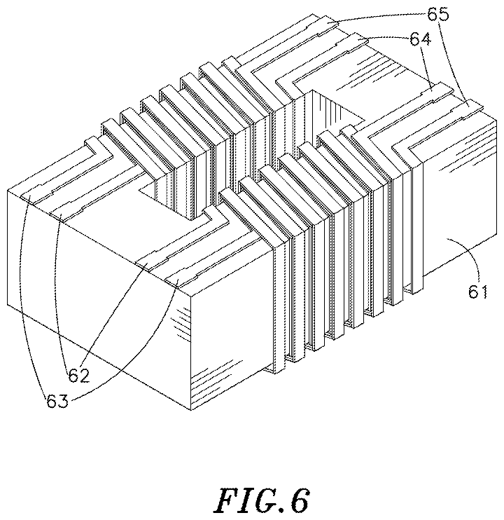

FIGS. 5 and 6 illustrate two different transformers made according to the present invention. In the small transformer shown in FIG. 5, one single primary coil winding 52 and one single secondary coil winding 53 are printed on a core base 51. Correspondingly, in order to adjust the magnetic flux and current of the transformer, it is also possible to print two sets of primary coil windings (62, 63) and two sets of secondary coil windings (64, 65) on a core base 61 as disclosed in FIG. 6. Therefore, printing a one or multiple sets of coil windings on a core base is within the scope and spirit of the present invention.

According to the disclosure shown in FIGS. 1A-FIG. 6, the magnetic inductor coil printing method of the present invention is to print at least one coil winding on a non-conductor core base, and then to print a first insulating layer on the non-conductor core base over the first coil winding, and then to print at least one second coil winding on the non-conductor core base over the first insulating layer, and then to print a second insulating layer on the non-conductor core base over the second coil winding. With the above structure, a small transformer is created, having the advantages of small size and space saving. In an alternate form of the present invention, the magnetic inductor coil printing method is to print a third insulating layer on a conductive core base, and then to print at least one third coil winding on the conductive core base over the third insulating layer, and then to print a fourth insulating layer on the conductive core base over the third coil winding, and then to provide at least one fourth coil winding on the conductive core base over the fourth insulating layer, and then to print a fifth insulating layer on the conductive core base over the fourth coil winding. With the above structure, a small transformer is created, having the advantages of small size and space saving. The above-described two kinds of transformer embodiments have great business opportunities in the small transformer market, so the patent application is filed to seek patent protection.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A magnetic inductor coil printing method, comprising the steps of:
(A1) printing at least one first coil winding on a non-conductor core base; and
(B1) printing a first insulating layer on said non-conductor core base over said first coil winding.

2. The magnetic inductor coil printing method as claimed in claim 1, further comprising the step of (C1) to print at least one second coil winding on said non-conductor core base over said first insulating layer.

3. The magnetic inductor coil printing method as claimed in claim 1, further comprising the step of (D1) to print a second insulating layer on said non-conductor core base over said second coil winding.

4. The magnetic inductor coil printing method as claimed in claim 1, wherein said non-conductor core base is selected from the material group of nickel-zinc alloys and nickel-zinc composite metals.

5. The magnetic inductor coil printing method as claimed in claim 1, wherein said first coil winding are made of a conductive liquid composed of conductive silver paste or graphite paste.

6. The magnetic inductor coil printing method as claimed in claim 2, wherein said second coil winding are made of a conductive liquid composed of conductive silver paste or graphite paste

7. A magnetic inductor coil printing method, comprising the steps of:
(A2) printing a third insulating layer on a conductive core base;
(B2) printing at least one third coil winding on said conductive core base over said third insulating layer; and
(C2) printing a fourth insulating layer on said conductive core base over said third coil winding.

8. The magnetic inductor coil printing method as claimed in claim 7, further comprising the step of (D2) to print at least one fourth coil winding on said conductive core base over said fourth insulating layer.

9. The magnetic inductor coil printing method as claimed in claim 7, further comprising the step of (E2) to print a fifth insulating layer on said conductive core base over said fourth coil winding.

10. The magnetic inductor coil printing method as claimed in claim 7, wherein said conductive core base is selected from the material group consisting of manganese-zinc alloys, manganese-zinc composite metals, silicon steel sheets and amorphous materials.

11. The magnetic inductor coil printing method as claimed in claim 7, wherein said third coil winding are made of a conductive liquid composed of conductive silver paste or graphite paste.

12. The magnetic inductor coil printing method as claimed in claim 8, wherein fourth coil winding are made of a conductive liquid composed of conductive silver paste or graphite paste.
